(19) United States
(12) Patent Application Publication
(10) Pub. No.: US 2008/0250160 A1
(43) Pub. Date: Oct. 9, 2008

(54) Address identification systems

(75) Inventor: Julian Hall, Cambridge (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Artimi, Inc., Santa Clara, CA (US)

(21) Appl. No.: 11/819,493

(22) Filed: Jun. 27, 2007

(30) Foreign Application Priority Data
Apr. 3, 2007 (GB) 0706484.3

(51) Int. Cl. G06F 3/00

(52) U.S. Cl. 710/3

(57) ABSTRACT

We describe a method, particularly useful for a ultra wideband (UWB) network, to enable a first device to determine whether a device address used by a second device is intended to identify said first device, in a network with a variable topology in which a device address may change, the method comprising: transmitting, repeatedly, a beacon to said second device updating a said device address of said first device; storing a history of device addresses used by said first device; receiving, at said first device, a signal including an address and comparing the received device address with addresses in the history back in time for a period limited by a synchronisation refresh time which comprises a maximum time for which said second device may fail to receive said beacon from said first device without considering that said first device is no longer synchronised to said network.

### BACKGROUND OF THE INVENTION

1. Field of the Invention

This invention relates to methods, apparatus and computer program code for identifying whether an address in a network with a variable topology in which a device address may change, is intended to identify a particular device. Embodiments of the invention are particularly useful in ultra wideband (UWB) distributed medium access control (MAC) wireless networks.

2. Background Art

Embodiments of the invention will be described with particular reference to standard ECMA-368 (First Edition, 2005); reference may also be made to similar standards published later by the WiMedia Alliance. The skilled person will understand, however, that applications of embodiments of the invention are not limited to such networks.

ECMA-368 defines a high rate ultra wideband PHY and MAC standard including a distributed protocol for access and allocation of addresses. There is no central control node and instead a distributed reservation protocol (DRP) is employed, broadly a device observing which resources are used by other devices and then making a choice of address and channel time; a conflict resolution protocol is also provided. Short (16 bit) device addresses are mainly used because these are easier and quicker to process and in general locally unique. However because of device mobility two devices can have the same address and there is therefore the possibility of address clashes, albeit with a low probability, and the potential for ambiguity.

A network also employs frequency reuse and each device beacons to its neighbour, mainly for the purposes of the MAC, inter alia to maintain synchronisation. A variable length beacon period is divided into 85 μs beacon slots and a device beacon provides information about the neighbours of a device (other devices it can “hear”—receive from) and therefore a received beacon can provide a device with information relating to its neighbour's neighbours including, in particular the occupancy of beacon slots. Broadly a device is able to transmit in a slot if it appears free and it also perceived as free by the device's neighbours' this enables spatial reuse of frequencies.

Communications in the MAC layer are organised into superframes, each superframe comprising 256 medium access slots each of 256 μs (a total of 65 ms). A device may use one or more MAS slots depending upon the requirements of a communication channel between devices. FIG. 1a, which is taken from ECMA-368, shows the MAC superframe structure and FIG. 1b shows details of a beacon period (BP).

FIG. 1c shows the general format of an example MAC frame for a beacon including from 1 to N information elements (IEs) for BPO (Beacon Period Occupancy) and DRP (Distributed Reservation Protocol) data, as well as other information elements. The MAC header comprises, in addition to control information and information identifying the type of frame (0 for a beacon frame), a source and destination address each specified by a 16 bit device address (DevAddr) which is generated locally by a device, essentially randomly avoiding addresses known to be used by neighbours and neighbour's neighbours. Most (but not all) devices also have a globally unique 48 bit extended unique identifier (EUI-48™) and provision is also made for including this value in a beacon. Device address clashes can be identified either by one device noting that another is using its own address as a source address, or by receiving similar information from a neighbour about its neighbours, that is that a neighbour's neighbour is using the device's own address as a source address.

The BPO information element provides information on the beacon period (see FIG. 1b) as observed by the device sending the BPOIE. FIG. 1d shows the structure of a beacon period occupancy information element; as can be seen this includes a bit map of occupied beacon slots, formatted as a variable length array with each element corresponding to a beacon slot and the DevAddr shown in FIG. 1d corresponding to the beacon slots encoded as occupied in the beacon slot information bit map (in sending beacon slot order). Beacon slots 0 and 1 are signalling slots used for a device to advertise when a slot is used, since the length of the beacon period (in terms of number of slots) is variable, for power saving, and thus devices extend their view of the beacon period as necessary.

As mentioned above, different applications have different requirements in terms of throughput and maximum delay (latency), and this translates into a repetition rate of an allocated time slot within a single superframe having a slot duration of n MAS periods, repeated in subsequent superframes. The pattern of MASs depends upon the type and priority of data—for example real time delay data requires a low latency whereas for bulk data transmission the delay is of little consequence but a large channel time is desirable.

The DRP protocol enables an initiating device (“owner”) to make a claim for channel time between the owner and another device (“target”). Broadly the owner device decides on the request and inserts a DRP information element in its outgoing beacon claiming some MASs which it believes are free DRP IEs in the beacons from other devices. Thus the owner sends a DRP and qualifies the target with a target address (DevAddr). The target device is responsible for granting the request and for providing ongoing reconfirmation during the period of use that the channel time requested by the owner remains free.

The inventors, however, have recognised that there is a problem with this approach, albeit relatively uncommon, which arises from ambiguity of the DevAddr address. The question is, to which device (owner/target) does the DevAddr in the information element correspond? The owner device puts the target device's DevAddr in the DRP IE and the target parses the incoming beacon to see whether or not its address is included and, if so, schedules channel time to receive data from the owner accordingly. However, if the target device has recently changed its address once or perhaps twice, the owner device may still be using an old address for the target. The question then arises, in this example from the target's perspective, does the owner mean me or another device?

### SUMMARY OF THE INVENTION

According to the invention there is therefore provided a method to enable a first device to determine whether a device address used by a second device is intended to identify said first device, said first and second devices comprising mobile devices forming part of a network of devices with a variable topology in which a said device address may change to resolve an address conflict within the network, the method comprising: transmitting, repeatedly, a beacon from said first device to said second device, said beacon including information updating a said device address of said first device; storing, in said first device, a history of device addresses used by said first device; receiving, at said first device, from said second device, a signal including a said device address; comparing, in said first device, said received device address with device addresses in said history of device addresses back in time for a period limited by a synchronisation refresh time, wherein said synchronisation refresh time comprises a maximum time for which said second device may fail to receive said beacon from said first device without considering that said first device is no longer synchronised to said network; and determining that said received device address is intended to identify said first device if said received device address matches a device address in said history of device addresses over said limited period.

In embodiments communications in the network are divided into superframes, each superframe comprising a plurality of data frames, and the transmitting of the beacon comprises transmitting a beacon data frame comprising beacon data. Then the synchronisation refresh time preferably comprises an integral number of the superframes, in some embodiments four.

In embodiments of a UWB network if the clock of one device runs as fast as possible within the defined tolerance limits and the clock of another device as slowly as possible within the tolerance limit then after greater than four superframes the worst case clock drift effectively desynchronises the devices and thus a device is effectively no longer part of the local group. Thus the address of a device can only be as old as the synchronisation refresh time, that is in embodiments a period of four superframes. Thus in embodiments a device maintains a history of its own addresses (or address changes) over the last four superframes. In this way a received device address can be compared with a device address in the history (either by searching through or by looking up a location specified by a received device address) to determine whether or not the received device address is intended to identify the device receiving the address. If the received device address is in the history it is assumed that it is intended to specify the device receiving the address; if the sender of the address (for example the owner device) really intended to identify a different target device then that other target device would qualify the address.

Embodiments of the above-described method may be employed in the DRP protocol of a UWB network, and also in conjunction with a beacon protocol, more particularly with the BPO IE. For example, as described above, broadly speaking a beacon reports occupied slots and, more particularly, one device listens to the beacons of other devices it can hear and reports these (so that a device can determine which slots are occupied by its neighbour's neighbours). Consider a case where a device, y, is occupying beacon slot x, and device y receives the beacon of another device indicating that slot x is also occupied by a device with address (DevAddr) z. The question then arises, is address z mine? If it is there is no problem, if not then device y should change the beacon slot it is occupying because it is used by another device. Embodiments of the above-described method can be employed to determine whether or not the address in a beacon (BPO IE) received from a second device at a first device identifies the first device, even if the beacon is received in the slot occupied by the first device, this is acceptable. However if the determination is made that the address does not identify the first device, and the beacon is in a slot occupied by the first device, then there is a (potential) conflict, in particular because this slot in a neighbour of the neighbour is occupied.

Since, in embodiments, only information obtained from a previous superframe is included in the BPO IE then the information may only be one superframe out of date. Thus where embodiments of the method are used in connection with beacon period occupancy a shorter view of the history, for example one or two superframes, may be sufficient.

Thus in another aspect there is provided a method to enable a first device to determine whether a device address used by a second device is intended to identify said first device, said first and second devices comprising mobile devices forming part of a network of devices with a variable topology in which a said device address may change to resolve an address conflict within the network, wherein communications in said network are divided into superframes, each superframe comprising a plurality of data frames, the method comprising: transmitting, repeatedly, a beacon from said first device to said second device, said beacon including information updating a said device address of said first device; storing, in said first device, a history of device addresses used by said first device; receiving, at said first device, from said second device, a signal including a said device address; comparing, in said first device, said received device address with device addresses in said history of device addresses back in time for a period comprising at least two said superframes, and determining that said received device address is intended to identify said first device if said received device address matches a device address in said history of device addresses over said period.

Embodiments of the method decrease the probability of an unnecessary move to another beacon slot, which would otherwise potentially carry a risk of destabilising the network. Embodiments of the method applied to beacon period occupancy information are not able to rely upon stream identification information (see below) for greater ambiguity resolution so there is a low risk of assuming there is no need to move when in fact there is, and hence a marginally increased collision risk. However overall the benefits of embodiments of the method outweigh this disadvantage.

Returning to previously described aspects of the method, in particular (but not necessarily) in relation to a distributed reservation protocol, qualification of a communication link may use more than an owner-target DevAddr) address pair. For example in embodiments of the method the DRP also employs a stream index, a separate number space associated with each address pair, more particularly a 3 bit number which aims to uniquely identify a reservation within the communications channel (because there may be multiple reservations between a single pair of devices, for different applications).

Thus in preferred embodiments a stream identifier of a current communications stream is also used for determining whether the received device address is intended to identify the receiving device. The qualification of a received device address to determine whether it is intended to identify a receiving device may further employ the set of medium access slots (MASs) used for a communications stream. The set of MASs is described in the DRP information element and is repeated (and may change) for each superframe. However broadly speaking for a communications stream between two devices it is expected that the set of MASs will remain the same, or at least will overlap (in the case where a conflict has required one or other end of the link to modify some of the MASs used). However the MASs employed would not be mutually exclusive from one superframe to another and thus a set of MASs of a current communication stream between first and second devices may be compared with a set of MASs identified by a signal such as a request for reservation of communications bandwidth to determine whether a received device address is intended to identify a receiving device. In embodiments, if there is no overlap (between the MASs in the current communications stream and those requested in the reservation) then it may be assumed that the received device address is not intended to identify the receiving device. There is a low risk of a false match but this is of little consequence compared with the consequence of not making a correct match, which is a break in the communications reservation which could result, say, in a jerky real-time video or audio sequence. (As previously mentioned, the superframe comprises 256 MASs, but an MAS may comprise more than one frame).

As previously mentioned, the beacon may include a global address associated with a local device address (DevAddr), that is an address which is useable to unambiguously identify a device. In this way a temporary local address can be guaranteed to be up to date. In embodiments the global address is an address allocated by a central or global address allocation system or authority, in particular an EUI-48 address. Thus when a global or EUI-48 address is received in a beacon, at that point an up to date view of the device address of the sending device is guaranteed (although on occasion, for example where a device does not have unique EUI-48 value, the device identifier field which would normally contain this address may be set to a null value. Alternatively (or additionally) to the above-described techniques, it may be mandated within the network that a device does not change its address more frequently than the synchronisation refresh time, for example four superframes (because another device may not hear your beacon for up to four superframes). However this does not remove the problem entirely since the time window, of say four superframes, is moving and thus there is the possibility of a single address change within the period.

According to a further aspect of the invention there is therefore provided a method to enable a first device to determine whether a device address used by a second device is intended to identify said first device, said first and second devices comprising mobile devices forming part of a network of devices with a variable topology in which a said device address may change to resolve an address conflict within the network, the method comprising: transmitting, repeatedly, a beacon from said first device to said second device, said beacon including information updating a said device address of said first device; receiving, at said first device, from said second device, a signal including a said device address; determining that said received device address is intended to identify said first device if said received device address matches a device address of said first device; and delaying for at least a synchronisation refresh time after a change of said device address of said first device before another change of said device address of said first device; and wherein said synchronisation refresh time comprises a maximum time for which said second device may fail to receive said beacon from said first device without considering that said first device is no longer synchronised to said network.

As mentioned above, embodiments of this method do not eliminate the risk of falsely identifying a received address as intended for the receiving device, but this risk is reduced and hence provides some advantages. However such a system is less responsive to a genuine address conflict because, potentially, there is a need to maintain an ambiguous address for up to the synchronisation refresh time, for example four superframes.

The invention still further provides processor control code to implement the above-described protocols and methods, in particular on a data carrier such as a disk, CD- or DVD-ROM, programmed memory such as read-only memory (Firmware), or on a data carrier such as an optical or electrical signal carrier. Code (and/or data) to implement embodiments of the invention preferably comprises code for a hardware description language such as Verilog (Trade Mark) or VHDL (Very high speed integrated circuit Hardware Description Language) or SystemC, although it may also comprise source, object or executable code in a conventional programming language (interpreted or compiled) such as C, or assembly code, or code for setting up or controlling an ASIC (Application Specific Integrated Circuit) or FPGA (Field Programmable Gate Array). As the skilled person will appreciate such code and/or data may be distributed between a plurality of coupled components in communication with one another.

In a further aspect the invention provides a first mobile device for communicating with a second mobile device over a network of devices with a variable topology in which an address of a said device many change to resolve an address conflict within the network, said first mobile device comprising: a transmitter to transmit, repeatedly, a beacon from said first device to said second device, said beacon including information updating a said device address of said first device; memory to store, in said first device, a history of device addresses used by said first device; a receiver to receive, at said first device, from said second device, a signal including a said device address; a comparator to compare, in said first device, said received device address with device addresses in said history of device addresses back in time for a period limited by a synchronisation refresh time, wherein said synchronisation refresh time comprises a maximum time for which said second device may fail to receive said beacon from said first device without considering that said first device is no longer synchronised to said network; and an address identifier to determine that said received device address is intended to identify said first device if said received device address matches a device address in said history of device addresses over said limited period.

The invention further provides a communications network including a plurality of mobile devices as described above, in particular a UWB communications network, more particularly compatible with standard ECMA-368.

### BRIEF DESCRIPTION OF THE DRAWINGS

These and other aspects of the invention will now be further described, by way of example only, with reference to the accompanying figures in which:

FIGS. 1a to 1d show, respectively, a MAC superframe structure, details of a beacon period (BP), a general format of an example MAC frame for a beacon including beacon period occupancy (BPO) and distributed reservation protocol (DRP) data, and structure of a BPO information element;

FIG. 2 shows a flow diagram of a procedure to determine whether an address in a DRP IE is intended to identify a device receiving the DRP IE, according to an embodiment of the invention;

FIG. 3 shows a MAC system for implementing the procedure of FIG. 2;

FIG. 4 shows a block diagram of a digital OFDM UWB transmitter sub-system;

FIG. 5 shows a block diagram of a digital OFDM UWB receiver sub-system; and

FIGS. 6a and 6b show, respectively, a block diagram of a PHY hardware implementation for an OFDM UWB transceiver and an example RF front end for the receiver of FIG. 6a.

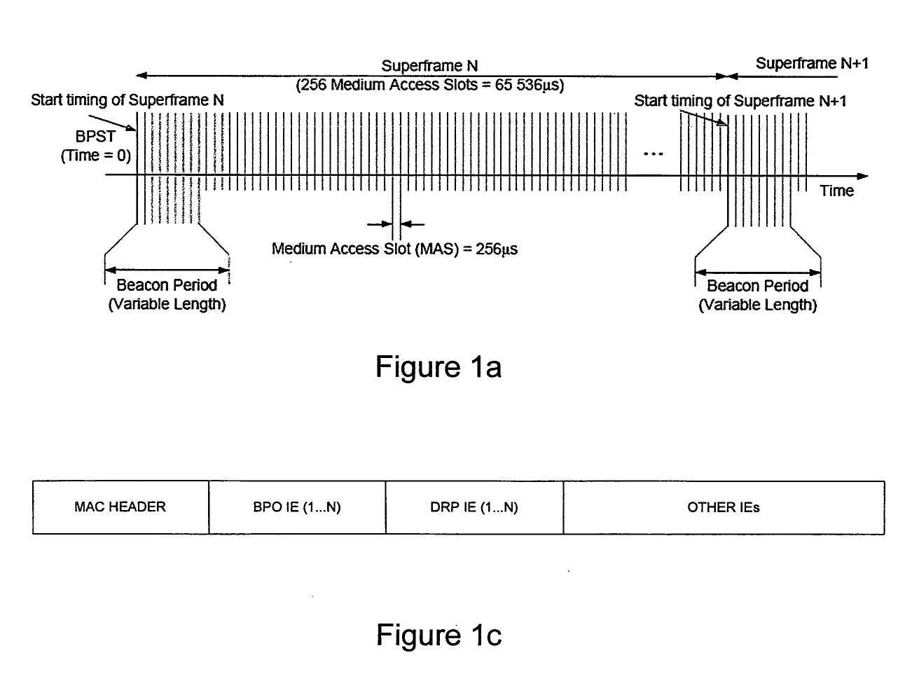

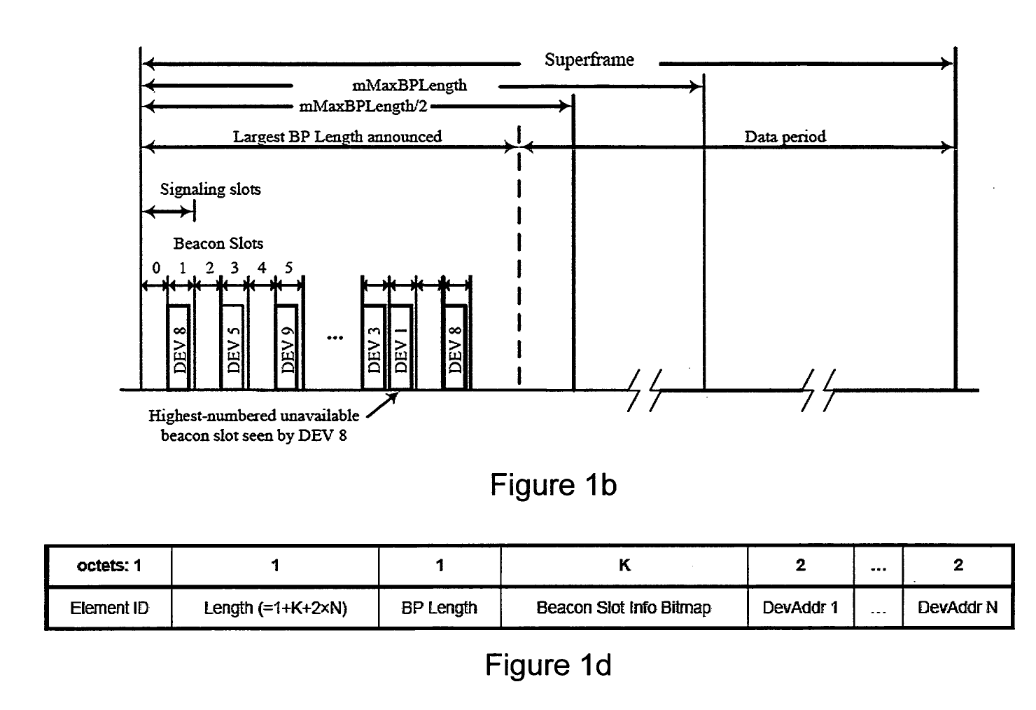

### DETAILED DESCRIPTION OF PREFERRED EMBODIMENTS

Broadly speaking we will describe a technique where, for each superframe, a device stores the address (DevAddr) it uses in its beacon for a time limited history, that is a sliding window over the last four superframes. We also use knowledge of how out of date another device's view of an address can be—for example if a device knows that it has not changed its address in the last four superframes then it also knows that local devices will not have a stale view of its address. However once a beacon has been received this guarantees that the address (DevAddr) is up to date because the beacon also includes the global EUI-48 address. Thus the time for which the history should be stored is the period for which a beacon can validly not be received.

In a corresponding way, when a DRP is received by a target, because the target may not necessarily have received the owner's most recent beacon the target's view of the owner's address may be out of date. However if the owner device maintains a history of its own addresses it can determine whether or not the target's response is intended for the owner (because the response will include the owner's address together with a granted or otherwise response to the broadcast DRP request for an allocation of channel time).

In more detail, an owner or target device holds n DRP reservation objects, each one qualified by:
1. Owner DevAddr;
2. Target DevAddr;
3. Stream Index
4. MAS Set

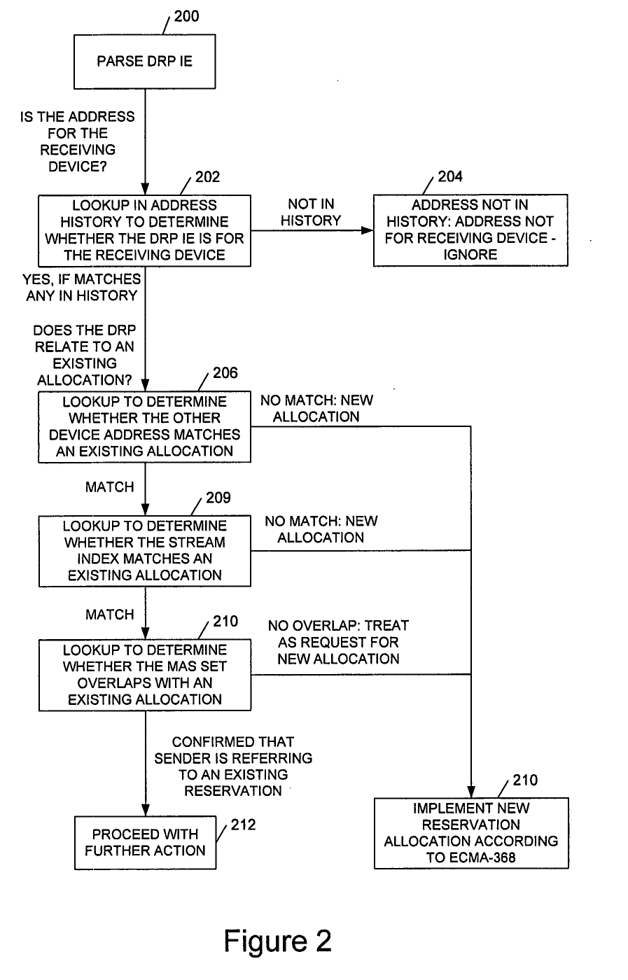

FIG. 2 shows a flow diagram of a procedure to determine whether an address in a DRP IE is intended to identify a device receiving the DRP IE. This procedure may be implemented in processor control code in a medium access control (MAC) sublayer of a UWB transceiver. The procedure may be implemented by either an owner or a target device to determine whether or not an address in a DRP IE is intended for the device receiving the address. The skilled person will understand that a very similar process may be employed for any other information element.

At step 200 the receiving device receives and parses a DRP IE to extract the address and then determines whether or not the address is for the receiving device by, initially (step 202) looking up in an address history table to determine whether the address is present in the table. If the address is not in the history then the DRP IE is not for the receiving device and can be ignored (step 204), but if the address matches any in the history then the procedure continues to perform further checks to determine whether the DRP relates to an existing allocation.

Thus at step 206 the procedure determines whether the other (sending) device address matches an existing allocation, and if not, implements a new reservation allocation according to standard ECMA-368 in the usual way. However if a match is found the procedure then checks the stream index (step 209) to determine whether this matches an existing allocation and again, if there is no match, proceeds to step 208 to implement a new reservation. However if a match is found the procedure then further checks the MAS set (step 210) to determine whether or not this overlaps with an existing allocation. If there is no overlap again the procedure continues to step 208 and the DRP is treated effectively as a request for a new allocation although, in reality, this is a request to modify (extend) an existing reservation—ultimately the new reservation will be combined with an existing allocation. If, however, at step 210 an overlap is found then it is confirmed that the sender is referring to an existing reservation and then the procedure continues (step 212) with further action accordingly. For example for a target device this may comprise sending a signal to indicate confirmation that the requested allocation is granted or, if the allocation is the same as previously, re-confirmation of this allocation. Alternatively an owner device may have received information from a target device relating to a conflict in which case the owner device is permitted (according to standard ECMA-368) to unilaterally modify the reservation.

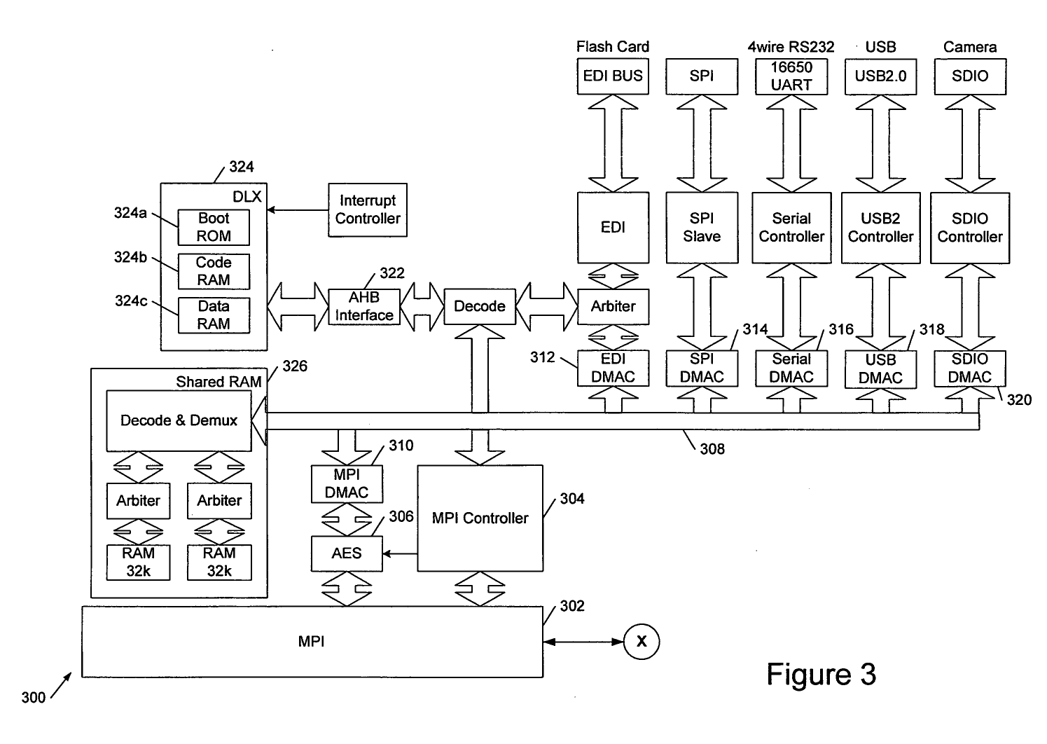

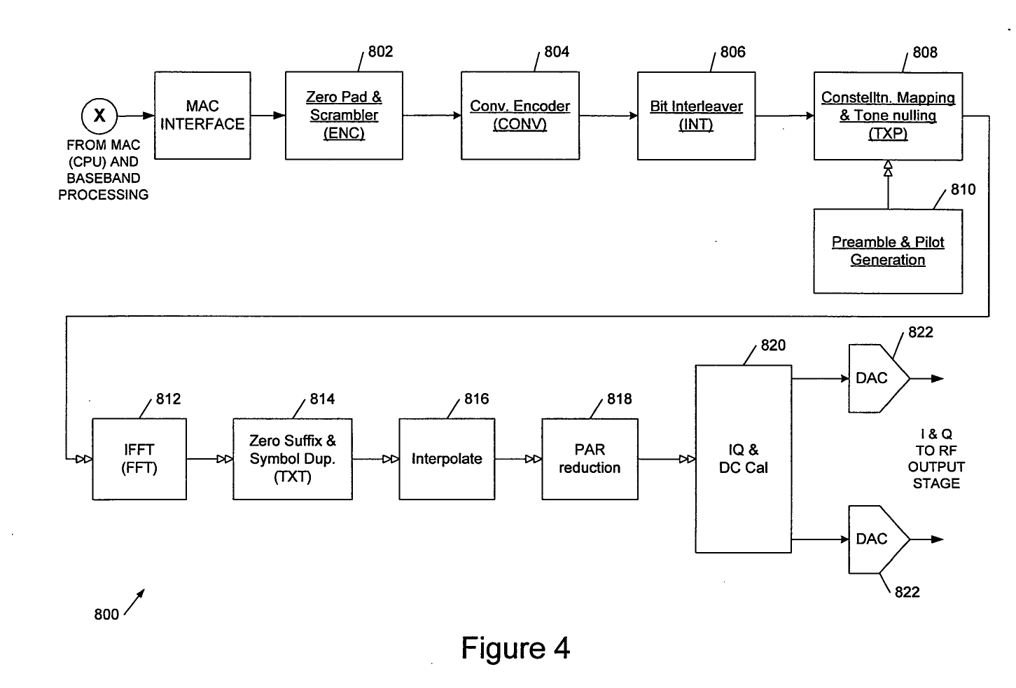

FIG. 3 shows a medium access control (MAC) system 300 for a UWB transceiver (the physical layers of which are described below with reference to FIGS. 4 to 6), the MAC system 300 being configured to implement a procedure as shown in FIG. 2.

The MAC system 300 comprises a message parsing interface (MPI) 302 with a bidirectional data and control connection, “X” to the physical layer hardware shown in FIGS. 4 to 6. The MPI 302 is coupled to an MPI controller 304, which also interfaces to AES (Advanced Encryption Standard) hardware 306, which has a separate connection to MPI 302. The MPI controller 304 is coupled to a bi-directional data and control bus 308 to which are coupled a plurality of DMAC (Direct Memory Access Control) units including an MPI DMAC 310, an EDI (Electronic Data Interchange) DMAC 312, an SPI (Serial Peripheral Interface) DMAC 314, a serial DMAC 316, a USB (Universal Serial Bus) DMAC 318 and an SDIO (Secure Digital I/O memory card) DMAC 320. Each of DMACs 312-320 is coupled to a respective controller and then to a corresponding interface. Bus 308 is also coupled to an AHB (Advanced High-Performane Bus) interface 322 which in turn is coupled to memory 324 including non-volatile code and data memory Boot ROM 324a, code memory (RAM) 324b and data memory (RAM) 324c; bus 308 is also coupled to shared memory (RAM) 326.

In embodiments of the MAC system 300 the Boot and/or code memory 324a, b stores implement a procedure as shown in FIG. 2; the address history data may be stored in data RAM 324c.

FIGS. 4 to 6 described below show functional and structural block diagrams of an OFDM UWB transceiver for use with the MAC hardware described above.

Thus referring to FIG. 4, this shows a block diagram of a digital transmitter sub-system 800 of an OFDM UWB transceiver. The sub-system in FIG. 4 shows functional elements; in practice hardware, in particular the (I) FFT may be shared between transmitting and receiving portions of a transceiver since the transceiver is not transmitting and receiving at the same time.

Data for transmission from the MAC CPU (central processing unit) is provided to a zero padding and scrambling module 802 followed by a convolution encoder 804 for forward error correction and bit interleaver 806 prior to constellation mapping and tone nulling 808. At this point pilot tones are also inserted and a synchronisation sequence is added by a preamble and pilot generation module 810. An IFFT 812 is then performed followed by zero suffix and symbol duplication 814, interpolation 816 and peak-2-average power ratio (PAR) reduction 818 (with the aim of minimising the transmit power spectral density whilst still providing a reliable link for the transfer of information). The digital output at this stage is then converted to I and Q samples at approximately 1 Gsps in a stage 820 which is also able to perform DC calibration, and then these I and Q samples are converted to the analogue domain by a pair of DACs 822 and passed to the RF output stage.

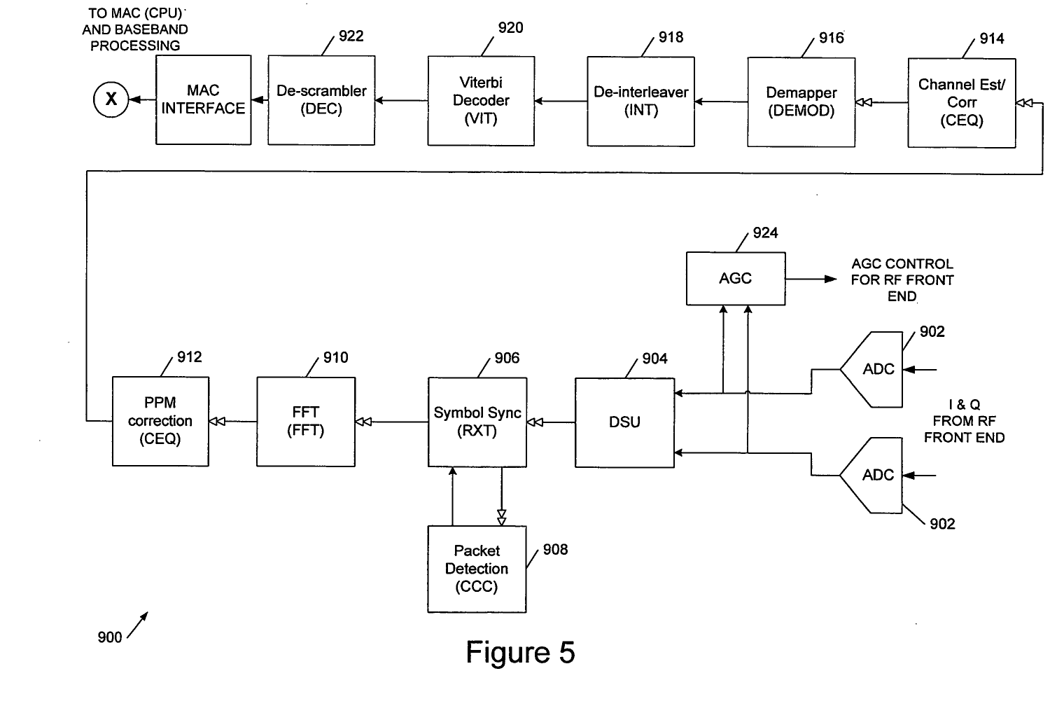

FIG. 5 shows a digital receiver sub-system 900 of a UWB OFDM transceiver. Referring to FIG. 5, analogue I and Q signals from the RF front end are digitised by a pair of ADCs 902 and provided to a down sample unit (DSU) 904. Symbol synchronisation 906 is then performed in conjunction with packet detection/synchronisation 908 using the preamble synchronisation symbols. An FFT 910 then performs a conversion to the frequency domain and ppm (parts per million) clock correction 912 is performed followed by channel estimation and correlation 914. After this the received data is demodulated 916, de-interleaved 918, Viterbi decoded 920, de-scrambled 922 and the recovered data output to the MAC. An AGC (automatic gain control) unit is coupled to the outputs of a ADCs 902 and feeds back to the RF front end for AGC control, also on the control of the MAC.

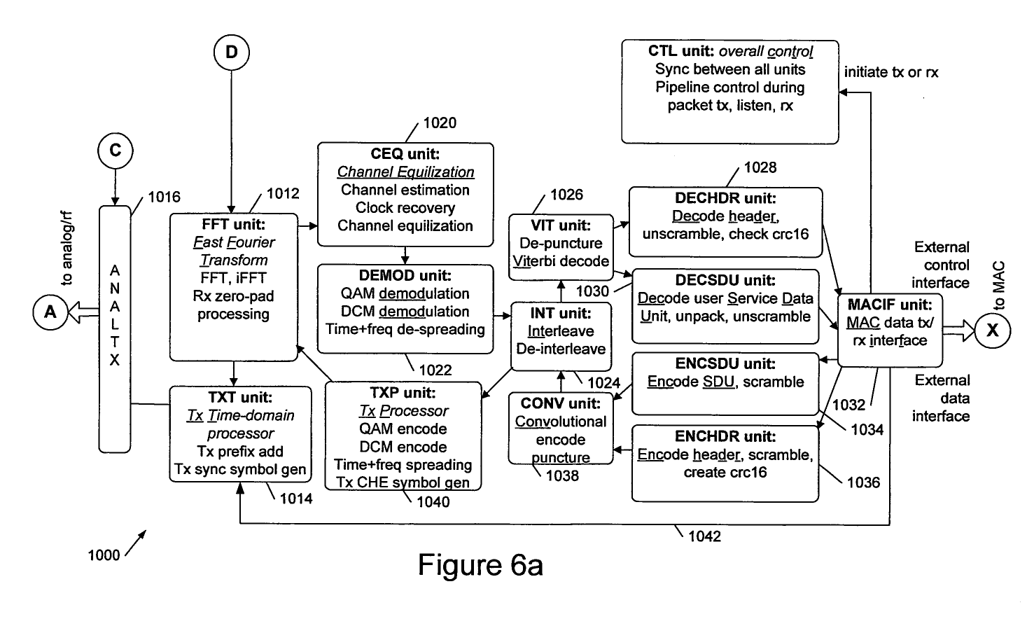

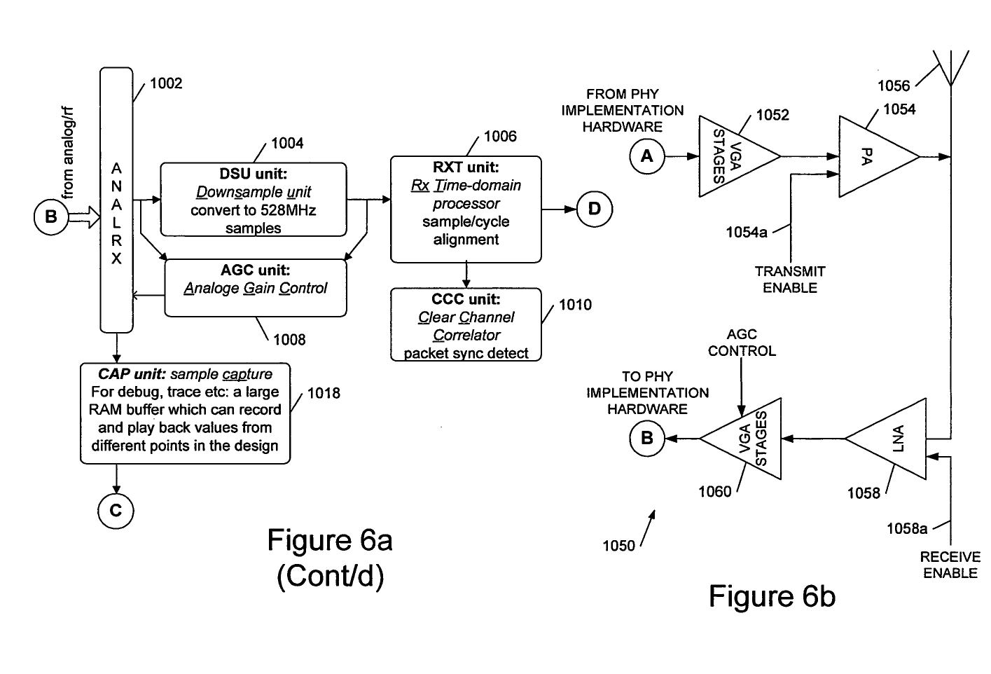

FIG. 6a shows a block diagram of physical hardware modules of a UWB OFDM transceiver 1000 which implements the transmitter and receiver functions depicted in FIGS. 4 and 5. The labels in brackets in the blocks of FIGS. 4 and 5 correspond with those of FIG. 6a, illustrating how the functional units are mapped to physical hardware.

Referring to FIG. 6a an analogue input 1002 provides a digital output to a DSU (down sample unit) 1004 which converts the incoming data at approximately 1 Gsps to 528 Mz samples, and provides an output to an RXT unit (receive time-domain processor) 1006 which performs sample/cycle alignment. An AGC unit 1008 is coupled around the DSU 1004 and to the analogue input 1002. The RXT unit provides an output to a CCC (clear channel correlator) unit 1010 which detects packet synchronisation; RXT unit 1006 also provides an output to an FFT unit 1012 which performs an FFT (when receiving) and IFFT (when transmitting) as well as receiver 0-padding processing. The FFT unit 1012 has an output to a TXT (transmit time-domain processor) unit 1014 which performs prefix addition and synchronisation symbol generation and provides an output to an analogue transmit interface 1016 which provides an analogue output to subsequent RF stages. A CAP (sample capture) unit 1018 is coupled to both the analogue receive interface 1002 and the analogue transmit interface 1016 to facilitate debugging, tracing and the like. Broadly speaking this comprises a large RAM (random access memory) buffer which can record and playback data captured from different points in the design.

The FFT unit 1012 provides an output to a CEQ (channel equalisation unit) 1020 which performs channel estimation, clock recovery, and channel equalisation and provides an output to a DEMOD unit 1022 which performs QAM demodulation, DCM (dual carrier modulation) demodulation, and time and frequency de-spreading, providing an output to an INT (interleave/de-interleave) unit 1024. The INT unit 1024 provides an output to a VIT (Viterbi decode) unit 1026 which also performs de-puncturing of the code, this providing outputs to a header decode (DECHDR) unit 1028 which also unscrambles the received data and performs a CRC 16 check, and to a decode user service data unit (DECSDU) unit 1030, which unpacks and unscrambles the received data. Both DECHDR unit 1028 and DECSDU unit 1030 provide output to a MAC interface (MACIF) unit 1032 which provides a transmit and receive data and control interface for the MAC.

In the transmit path the MACIF unit 1032 provides outputs to an ENCSDU unit 1034 which performs service data unit encoding and scrambling, and to an ENCHDR unit 1036 which performs header encoding and scrambling and also creates CRC 16 data. Both ENCSDU unit 1034 and ENCHDR unit 1036 provide outputs to a convolutional encode (CONV) unit 1038 which also performs puncturing of the encoded data, and this provides an output to the interleave (INT) unit 1024. The INT unit 1024 then provides an output to a transmit processor (TXP) unit 1040 which, in embodiments, performs QAM and DCM encoding, time-frequency spreading, and transmit channel estimation (CHE) symbol generation, providing an output to (I)FFT unit 1012, which in turn provides an output to TXT unit 1014 as previously described.

Referring now to FIG. 6b, this shows, schematically, RF input and output stages 1050 for the transceiver of FIG. 6a. The RF output stages comprise VGA stages 1052 followed by a power amplifier 1054 coupled to antenna 1056. The RF input stages comprise a low noise amplifier 1058, coupled to antenna 1056 and providing an output to further multiple VGA stages 1060 which provide an output to the analogue receive input 1002 of FIG. 6a. The power amplifier 1054 has a transmit enable control 1054a and the LNA 1058 has a receive enable control 1058a; these are controlled to switch rapidly between transmit and receive modes.

No doubt many other effective alternatives will occur to the skilled person. For example, although embodiments of the techniques have been described with reference to DRP data the skilled person will understand that similar techniques may also be employed with beacon data, more specifically BPO data. Further, more generally, the techniques we describe may be employed in any network with a variable topology in which an address may change, for example to resolve an address conflict, and applications of the technique are not limited to UWB networks.

It will therefore be understood that the invention is not limited to the described embodiments and encompasses modifications apparent to those skilled in the art lying within the spirit and scope of the claims appended hereto.

What is claimed is:

1. A method to enable a first device to determine whether a device address used by a second device is intended to identify said first device, said first and second devices comprising mobile devices forming part of a network of devices with a variable topology in which a said device address may change to resolve an address conflict within the network, the method comprising:
transmitting, repeatedly, a beacon from said first device to said second device, said beacon including information updating a said device address of said first device;
storing, in said first device, a history of device addresses used by said first device;
receiving, at said first device, from said second device, a signal including a said device address;
comparing, in said first device, said received device address with device addresses in said history of device addresses back in time for a period limited by a synchronisation refresh time, wherein said synchronisation refresh time comprises a maximum time for which said second device may fail to receive said beacon from said first device without considering that said first device is no longer synchronised to said network; and
determining that said received device address is intended to identify said first device if said received device address matches a device address in said history of device addresses over said limited period.

2. A method as claimed in claim 1 wherein said signal includes a stream identifier to identify one of a plurality of communications streams between said first and second devices, the method further comprising comparing a said stream identifier of a current communications stream between said first and second devices with a stream identifier in said signal for said determining of whether said received device address is intended to identity said first device.

3. A method as claimed in claim 1 wherein communications in said network are divided into superframes, each superframe comprising a plurality of data frames, and wherein transmitting of said beacon comprises transmitting a beacon data frame comprising beacon data.

4. A method as claimed in claim 3 wherein a said superframe has a plurality of beacon timeslots for a plurality of said beacon data frames, wherein said beacon data includes data specifying a said device address and a beacon timeslot occupied by a device identified by said device address, and wherein the method further comprises determining whether a said device address identifying an occupied beacon timeslot identifies said first device to identify a potential beacon timeslot occupancy conflict.

5. A method as claimed in claim 3 wherein said synchronisation refresh time comprises an integral number of said superframes.

6. A method as claimed in claim 5 wherein said integral number is four.

7. A method as claimed in claim 1 wherein communications in said network are divided into superframes, each superframe comprising a plurality of medium access slots (MASs), wherein said signal includes information identifying a set of said medium access slots (MASs) for a communications stream between said first and second devices, the method further comprising comparing a set of MASs of a current communications stream between said first and second devices with said set of MASs identified by said signal for said determining of whether said received device address is intended to identify said first device.

8. A method as claimed in claim 1 wherein said signal received from said second device comprises a said beacon transmitted by said second device.

9. A method as claimed in claim 1 wherein said network comprises an ultra wideband network compatible with standard ECMA-368, and wherein said device address included in said signal comprises one or both of an address in a BPO and in a DRP information element.

10. A method to enable a first device to determine whether a device address used by a second device is intended to identify said first device, said first and second devices comprising mobile devices forming part of a network of devices with a variable topology in which a said device address may change to resolve an address conflict within the network, wherein communications in said network are divided into superframes, each superframe comprising a plurality of data frames, the method comprising:
transmitting, repeatedly, a beacon from said first device to said second device, said beacon including information updating a said device address of said first device;
storing, in said first device, a history of device addresses used by said first device;
receiving, at said first device, from said second device, a signal including a said device address;
comparing, in said first device, said received device address with device addresses in said history of device addresses back in time for a period comprising at least two said superframes, and
determining that said received device address is intended to identify said first device if said received device address matches a device address in said history of device addresses over said period.

11. A method as claimed in claim 10 wherein transmitting of said beacon comprises transmitting a beacon data frame comprising beacon data, wherein a said superframe has a plurality of beacon timeslots for a plurality of said beacon data frames, wherein said beacon data includes data specifying a said device address and a beacon timeslot occupied by a device identified by said device address, and wherein the method further comprises determining whether a said device address identifying an occupied beacon timeslot identifies said first device to identify a potential beacon timeslot occupancy conflict.

12. A method as claimed in claim 10 wherein said signal received from said second device comprises a said beacon transmitted by said second device.

13. A method as claimed in any claim 10 wherein said network comprises an ultra wideband network compatible with standard ECMA-368, and wherein said device address included in said signal comprises one or both of an address in a BPO and in a DRP information element.

14. A method to enable a first device to determine whether a device address used by a second device is intended to identify said first device, said first and second devices comprising mobile devices forming part of a network of devices with a variable topology in which a said device address may change to resolve an address conflict within the network, the method comprising:
transmitting, repeatedly, a beacon from said first device to said second device, said beacon including information updating a said device address of said first device;
receiving, at said first device, from said second device, a signal including a said device address;
determining that said received device address is intended to identify said first device if said received device address matches a device address of said first device; and
delaying for at least a synchronisation refresh time after a change of said device address of said first device before another change of said device address of said first device; and
wherein said synchronisation refresh time comprises a maximum time for which said second device may fail to receive said beacon from said first device without considering that said first device is no longer synchronised to said network.

15. A method as claimed in claim 14 wherein communications in said network are divided into superframes, and wherein said synchronisation refresh time comprises an integral number of said superframes.

16. A method as claimed in claim 15 wherein said integral number is four.

17. A method as claimed in of claim 14 further comprising storing, in said first device, a history of device addresses used by said first device, said history comprising at least two said device addresses, and wherein said determining that said received device address is intended to identify said first device comprises comparing, in said first device, said received device address with device addresses in said history of device addresses.

18. A UWB communications network configured to operate in accordance with the method of claim 1.

19. A carrier carrying processor control code to, when running, implement the method of claims 1.

20. A first mobile device for communicating with a second mobile device over a network of devices with a variable topology in which an address of a said device many change to resolve an address conflict within the network, said first mobile device comprising:
a transmitter to transmit, repeatedly, a beacon from said first device to said second device, said beacon including information updating a said device address of said first device;
memory to store, in said first device, a history of device addresses used by said first device;
a receiver to receive, at said first device, from said second device, a signal including a said device address;
a comparator to compare, in said first device, said received device address with device addresses in said history of device addresses back in time for a period limited by a synchronisation refresh time, wherein said synchronisation refresh time comprises a maximum time for which said second device may fail to receive said beacon from said first device without considering that said first device is no longer synchronised to said network; and
an address identifier to determine that said received device address is intended to identify said first device if said received device address matches a device address in said history of device addresses over said limited period.

21. A communications network including a plurality of mobile devices each as claimed in claim 20.

22. A communications network as claimed in claim 21 wherein the network is a UWB communications network compatible with standard ECMA-368.
